(19) United States
(12) Patent Application Publication
(10) Pub. No.: US 2007/0032161 A1
(43) Pub. Date: Feb. 8, 2007

(54) Emissive-reflective display and method thereof

(76) Inventors: Chi-Chang Liao, Tai Nan City (TW); Hsing-Lung Wang, Ping Jen City (TW); Yung-Hui Yeh, Hsin Chu City (TW)

Correspondence Address: RABIN & BERDO, P.C., Suite 500, 1101 14 Street, N.W., Washington, DC, 20005, US

(21) Appl. No.: 11/346,443

(22) Filed: Feb. 3, 2006

(30) Foreign Application Priority Data
Aug. 8, 2005 (TW) 94126714

(51) Int. Cl. H01J 9/46

(52) U.S. Cl. 445/66

(57) ABSTRACT

An emissive-reflective display and method thereof is proposed for different prior art display technologies. The self-emissive component and the reflective component of the present invention are processed individually, and a simply paste method (such as roll-to-roll pressing or adding rubber materials) is utilized to finish the emissive-reflective display. The method of the present invention can improve the overall process yield.

### BACKGROUND OF THE INVENTION

1. Field of the Invention

The present invention relates to a display and method thereof, and more particularly an emissive-reflective display and method thereof.

2. Description of Related Art

A reflective non-emissive display comes with a power saving feature and a capability of maintaining a good viewing quality in a very bright environment, and the reflective non-emissive display such as a reflective LCD, a cholesterol LCD, and an electrophoretic display combines a reflective panel and a liquid crystal device.

A self-emissive display such as an organic light emitting diode (OLED) and a polymer light emitting diode (PLED) provides better image quality in a darker environment without the needs of using a polarizer, a backlight source, or a light compensation film to achieve the wide-angle, high-contrast, and fast response features.

As to the prior art display devices adopting the self-emissive components, there are many issued and disclosed patents and these prior art display devices are divided into penetrating self-emissive displays, reflective self-emissive displays and emissive-reflective self-emissive displays.

As to the prior art penetrating self-emissive displays, U.S. Pat. Publication No. 20020196387A1 entitled “Electro-optical device, method for driving electro-optical device, electronic apparatus, and method for driving electronic apparatus” discloses an electro-optical device, method for driving electro-optical device, electronic apparatus, and method for driving electronic apparatus, and comprises a detection device for detecting the brightness of a light source, and an active device for driving a self-emission layer or a reflective layer.

As to the prior art reflective self-emissive display, U.S. Pat. Publication No. 20030201960A1 entitled “Display device and driving method thereof” discloses a method of selecting the reflective or self-emissive function for an external light source by the modulation of a liquid crystal layer.

As to the prior art emissive-reflective self-emissive display, U.S. Pat. Publication No. 20030218595A1 entitled “Electronic display” discloses a driving device comprised of double electrophoretic substrates and double self-emissive substrates. This patent further specifies four substrates driven and combined by the double self-emissive substrates of an electronic device, and thus making the related manufacturing process more complicated.

Further, U.S. Pat. Publication No. 20040051445A1 entitled “Display device” discloses a light emitting device installed with a plurality of matrix pixels, and the display device comprises a light emitting layer and a reflective device installed at the back of the light emitting layer.

Referring to FIG. 1 for the schematic view of a prior art emissive-reflective self-emissive display device, the device comprises a ferroelectric liquid crystal display device 10 and an organic light emitting display component 30. The ferroelectric liquid crystal display device 10 includes a polarized layer 12, a first substrate 14, a second substrate 16, a plurality of alignment layers 18, a plurality of spacers 20 and a plurality of electrode layers 22, wherein the first substrate 14 and the second substrate 16 are plastic substrates. The organic light emitting display component 30 comprises a third substrate 32, a fourth substrate 34, a plurality of electrode layers 22, and a polymer layer 36, wherein the third substrate 32 and the fourth substrate 34 are glass substrates. Since the thickness of the emissive-reflective self-emissive display device produced by combining the second substrate 16 and the third substrate 32 is relatively large, therefore a poor reflection and vision may result.

In the foregoing disclosed patents, the self-emissive display comes with a high resolution and a high contrast and has a power saving feature better than the traditional backlight penetrating LCD, however it is not easy to distinguish such feature in an outdoor or a strong light environment. On the other hand, the reflective display features good outdoor visibility and low power consumption. Therefore, a good outdoor low-power display device can be produced by integrating the advantages of the aforementioned two displays. The manufacturing process of the foregoing emissive-reflective display must go with the manufacturing processes of the self-emissive components and the reflective components, and thus the manufacturing process is very complicated and difficult to achieve.

### SUMMARY OF THE INVENTION

The present invention provides a emissive-reflective display and method thereof that are produced by both self-emissive components and reflective components for simplifying the related manufacturing process and design to reduce the complexity of the manufacturing process.

To achieve the foregoing objective, the method of manufacturing a emissive-reflective display comprises the steps of: providing an upper substrate and a lower substrate; forming an upper electrode layer on the upper substrate; producing a plurality of reflective components on the upper electrode layer; producing a plurality of thin film transistor layers on the lower substrate; producing a plurality of self-emissive components on the thin film transistor layers; producing a lower electrode layer on the self-emissive components; and combining the upper substrate having the reflective components with the lower substrate having the self-emissive components.

The present invention also provides a emissive-reflective display comprising an upper substrate and a lower substrate; an upper electrode layer formed onto the upper substrate; a plurality of reflective components produced on the upper electrode layer; a plurality of thin film transistor layers produced on the lower substrate; a plurality of self-emissive components produced on the thin film transistor layers; a lower electrode layer produced on the self-emissive components; and the upper substrate having the reflective components combined with the lower substrate having the self-emissive component.

### BRIEF DESCRIPTION OF THE DRAWINGS

FIG. 1 is a schematic view of a prior art emissive-reflective semi-penetrating display;

FIG. 2 is a schematic view of the manufacturing process of an upper substrate of an emissive-reflective display according to a first preferred embodiment of the present invention;

FIG. 3 is a schematic view of the manufacturing process of a reflective component of an emissive-reflective display according to a first preferred embodiment of the present invention;

FIG. 4 is a schematic view of the manufacturing process of a lower substrate of an emissive-reflective display according to a first preferred embodiment of the present invention;

FIG. 5 is a schematic view of the manufacturing process of a self-emissive component of an emissive-reflective display according to a first preferred embodiment of the present invention;

FIG. 6 is a schematic view of the manufacturing process of a lower electrode layer of an emissive-reflective display according to a first preferred embodiment of the present invention;

FIG. 7 is a schematic view of the assembling and manufacturing process of an emissive-reflective display according to a first preferred embodiment of the present invention;

FIG. 8 is a schematic view of a emissive-reflective display according to a first preferred embodiment of the present invention; and

FIG. 9 is a schematic view of an emissive-reflective display according to a second preferred embodiment of the present invention.

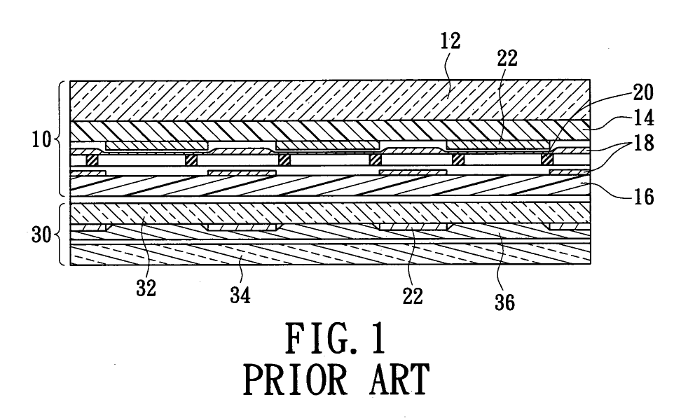

### DETAILED DESCRIPTION OF PREFERRED EMBODIMENTS

To make it easier for our examiner to understand the innovative features and technical content, preferred embodiments are used together with the attached drawings for the detailed description of the invention, but it should be pointed out that the attached drawings are provided for reference and description but not for limiting the present invention.

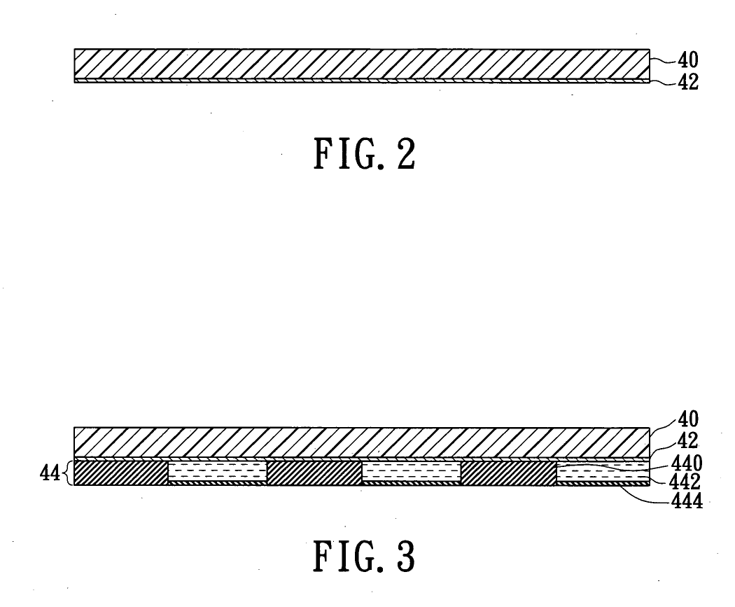

The present invention provides a simplified manufacturing process design to produce self-emissive components and reflective components separately on different substrates, and then uses a simple adhesion technology to combine the two substrates and complete the manufacture of the emissive-reflective display. Referring to FIGS. 2 to 7 for the schematic views of the manufacturing process of the emissive-reflective display according to a first preferred embodiment of the present invention, the process comprises the following steps.

Referring to FIG. 2 for the schematic view of a manufacturing process of an upper substrate of a emissive-reflective display according to a first preferred embodiment of the present invention, the manufacturing process comprises the steps of providing an upper substrate 40, wherein the upper substrate 40 is a glass substrate or a plastic substrate; and then forming an upper electrode layer 42 on the upper substrate 40. A plurality of color filter layers (not shown in the figure) is disposed between the upper substrate 40 and the upper electrode layer 42, and the disposition of these color filter layers depends on the filled display medium, but this manufacturing process may or may not dispose the color filter layer. If the filled display medium is made of cholesteric liquid crystals or electrophoretic, then it is not necessary to dispose the color filter layer. If the filled display medium is made of reflective liquid crystals, then it is necessary to dispose the color filter layer. Referring to FIG. 3 for the schematic view of the manufacturing process of a reflective component of a emissive-reflective display according to a first preferred embodiment of the present invention, a plurality of reflective components 44 is made on the upper electrode layer 42; wherein each reflective component 44 comprises a plurality of reflective media, and these reflective media could be cholesteric liquid crystals, reflective liquid crystals or electrophoretic. During the manufacturing process of the reflective components 44, a plurality of walls 440 is made on the upper electrode layer 42, and the walls 440 are made by photolithography, casing, screen printing and ink-jet manner, and the material used may be a polymer material; a plurality of reflective media 442 is filled among the walls 440, and these reflective media 442 are filled by a coating process, an one drop filling (ODF) process, or an ink-jet printing manner; and a plurality of protective layers 444 is formed on the reflective media 442, and these protective layers 444 are formed by an ink-jet method or a coating manner.

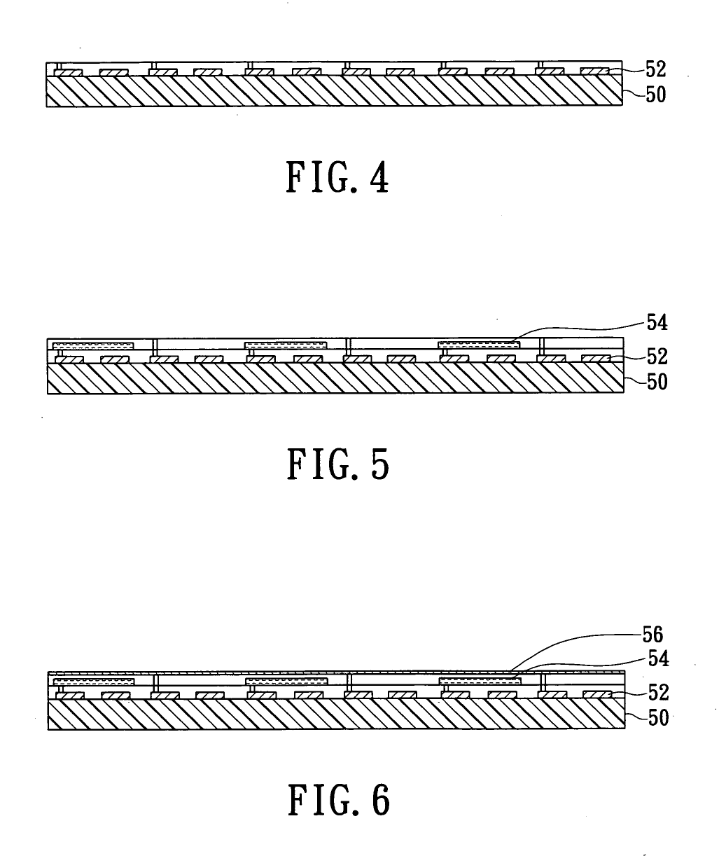

Referring to FIG. 4 for the schematic view of a manufacturing process of a lower substrate of a emissive-reflective display according to a first preferred embodiment of the present invention, the process comprises the step of providing a lower substrate 50, wherein the lower substrate 50 is a glass substrate or a plastic substrate; and then making a plurality of thin film transistor layers 52 on the lower substrate 50.

Referring to FIG. 5 for the schematic view of a manufacturing process of a self-emissive component of an emissive-reflective display according to a first preferred embodiment of the present invention, the thin film transistor layers 52 are made on a plurality of self-emissive components 54, wherein the self-emissive components 54 are made of a self-emissive material.

Referring to FIG. 6 for the schematic view of a lower electrode layer of a emissive-reflective display according to a first preferred embodiment of the present invention, the self-emissive components 54 are produced on a lower electrode layer 56, wherein the lower electrode layer acts as a passive matrix layer or an active matrix.

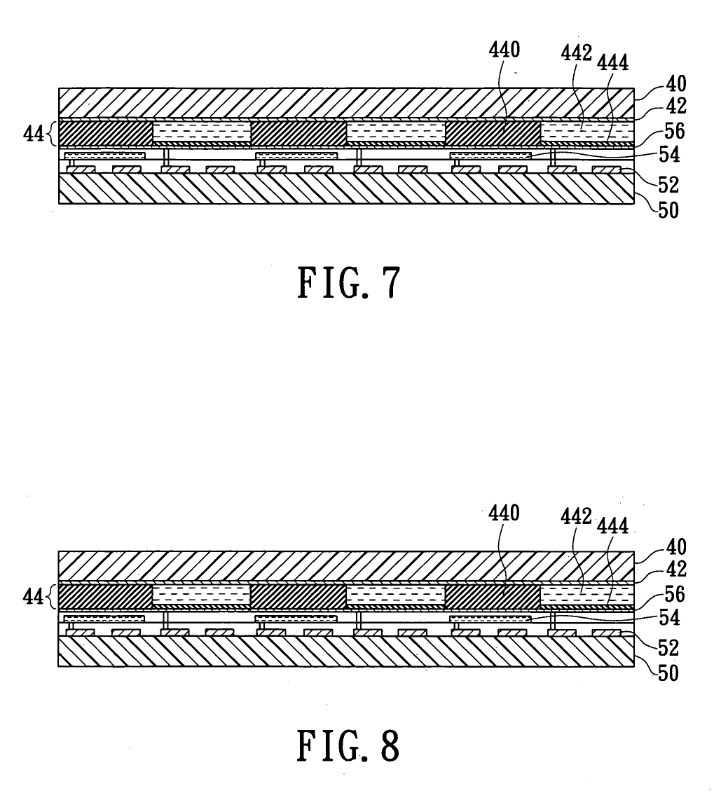

Referring to FIG. 7 for the schematic view of a manufacturing process of an emissive-reflective display according to a first preferred embodiment of the present invention, the upper substrate 40 having the reflective components 44 is combined with the lower substrate 50 having the self-emissive components 54. If the upper substrate 40 or the lower substrate 50 is a plastic substrate, then the rolling manner is adopted for direct pressing; if the upper substrate 40 or the lower substrate 50 is a glass substrate, then a plastic material (not shown in the figure) is adopted for adhesions, and the selected plastic material could be a curing resin or a thermal curing resin.

Referring to FIG. 8 for the schematic view of a emissive-reflective display according to a first preferred embodiment of the present invention, the emissive-reflective display comprises an upper substrate 40 and a lower substrate 50, wherein the upper substrate 40 and the lower substrate 50 are glass substrates or plastic substrates; an upper electrode layer 42 formed on the upper substrate 40 and further comprising a plurality of color filter layers (not shown in the figure) disposed between the upper substrate 40 and the upper electrode layer 42, and the disposition of these color filter layers depends on the display medium, and the color filter layer may or may not be disposed during this process; a plurality of reflective components 44 made on the upper electrode layer 42; a plurality of thin film transistor layers 52 made on the lower substrate 50, and the manufacturing process of these reflective components 44 comprises the step of producing a plurality of walls 440 on the upper electrode layer 42, wherein the walls 440 are made of a macromolecular material.

A plurality of reflective medium 442 is filled among the walls 440; and a plurality of protective layers 444 is formed on the reflective media 442 to make the reflective components 44. A plurality of self-emissive components 54 is made on the thin film transistor layers 52, wherein the self-emissive components 54 are made of a self-emissive material; a lower electrode layer 56 is made on the self-emissive components and further 54 comprises a plastic material (not shown in the figure) formed between the protective layers 444 and the lower electrode layers 56, wherein the plastic material is a curing resin or a thermal curing resin, and the upper substrate 40 having the reflective components 44 is combined with the lower substrate 50 having the self-emissive component 54. If the upper substrate 40 or the lower substrate 50 is a plastic substrate, then a rolling manner is adopted for a direct pressing; if the upper substrate 40 and the lower substrate 50 are glass substrates, then the plastic material (not shown in the figure) is adopted for adhesions.

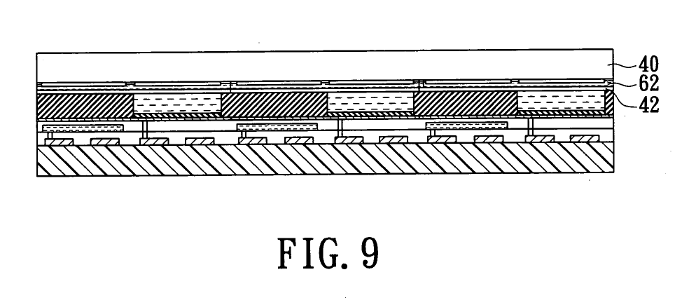

Referring to FIG. 9 for the schematic view of a emissive-reflective display according to a second preferred embodiment of the present invention, the difference with the first preferred embodiment resides on that the upper substrate 40 and the upper electrode layer 42 of this embodiment dispose a plurality of color filter layers 62 to make a emissive-reflective display having these color filter layers.

The present invention can simplify the manufacturing process of the emissive-reflective display and improve the overall process yield as described in the foregoing preferred embodiments, and the reflective components of the upper substrate and the self-emissive components of the lower substrate are prior art manufacturing technologies, and the present invention separately manufactures the reflective components and the self-emissive components and then combines these components by a simple adhesion method (such as direct pressing or adding a plastic material) to complete the manufacture of the emissive-reflective display, and thus improving the overall process yield.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of manufacturing an emissive-reflective (emi-flective) display, comprising:
providing an upper substrate and a lower substrate;
forming an upper electrode layer on said upper substrate;
making a plurality of reflective components on said upper electrode layer;
making a plurality of thin film transistor layers on said lower substrate;
making a plurality of self-emissive components on said thin film transistor layers;
making a lower electrode layer on said self-emissive components; and
combining said upper substrate having said reflective components with said lower substrate having said self-emissive components.

2. The method of manufacturing an emissive-reflective display of claim 1, wherein said upper substrate and said lower substrate are glass substrates or plastic substrates.

3. The method of manufacturing an emissive-reflective display of claim 1, further comprising a step of disposing a plurality of color filter layers between said upper substrate and said upper electrode layer.

4. The method of manufacturing an emissive-reflective display of claim 1, wherein said each reflective component comprises a plurality of reflective media.

5. The method of manufacturing an emissive-reflective display of claim 1, wherein said reflective medium is made of cholesteric liquid crystals, reflective liquid crystals, or electrophoretic display media.

6. The method of manufacturing an emissive-reflective display of claim 1, wherein said reflective component is manufactured by a process comprising the steps of:
producing a plurality of walls on said upper electrode layer;
filling a plurality of reflective media among said walls; and
forming a plurality of protective layers on said reflective medium.

7. The method of manufacturing an emissive-reflective display of claim 6, wherein said walls is produced by photolithography, casting, screen printing and/or ink-jet manner.

8. The method of manufacturing an emissive-reflective display of claim 6, wherein said barrier is made of a polymer material.

9. The method of manufacturing an emissive-reflective display of claim 6, wherein said reflective media are filled by a coating process, an one drop filling process, or an ink-jet printing manner.

10. The method of manufacturing an emissive-reflective display of claim 6, wherein said protective layers are formed by an ink-jet method or a coating manner.

11. The method of manufacturing an emissive-reflective display of claim 1, wherein said self-emissive components are made of a self-emissive material.

12. The method of manufacturing an emissive-reflective display of claim 1, wherein said combining step is accomplished by direct pressing or adding a plastic material.

13. The method of manufacturing an emissive-reflective display of claim 12, wherein said plastic material is a curing resin or a thermal curing resin.

14. An emissive-reflective display, comprising:
an upper substrate and a lower substrate;
an upper electrode layer, formed on said upper substrate;
a plurality of reflective components, made on said upper electrode layer;
a plurality of thin film transistor layers, made on said lower substrate; a plurality of self-emissive components, made on said thin film transistor layers;
a lower electrode layer, made on said self-emissive components; and
said upper substrate having said reflective components being combined with said lower substrate having said self-emissive components.

15. The emissive-reflective display of claim 14, wherein said upper substrate and said lower substrate are glass substrates or plastic substrates.

16. The emissive-reflective display of claim 14, further comprising a plurality of color filter layers disposed between said upper substrate and said upper electrode layer.

17. The emissive-reflective display of claim 14, wherein said reflective component comprising:
a plurality of walls, made on said upper electrode layer;
a plurality of reflective media, filled among said walls; and
a plurality of protective layers, formed on said reflective media.

18. The emissive-reflective display of claim 17, wherein said walls is made of a polymer material.

19. The emissive-reflective display of claim 14, wherein said self-emissive components are made of a self-emissive material.

20. The emissive-reflective display of claim 14, wherein said upper substrate is rolled for a direct pressing, if said upper substrate is a plastic substrate.

21. The emissive-reflective display of claim 14, further comprising a plastic material formed between said protective layers and said lower electrode layer.

22. The emissive-reflective display of claim 21, wherein said plastic material is a curing resin or a thermal curing resin.
